(19) United States
(12) Patent Application Publication
(10) Pub. No.: US 2002/0132642 A1
(43) Pub. Date: Sep. 19, 2002

(54) Common module combiner/active array multicarrier approach without linearization loops

(76) Inventors: John Ned Hines, Morristown, NJ (US); Gary M. Hojell, Kinnelon, NJ (US)

Correspondence Address: HARNESS, DICKEY & PIERCE, P.L.C., P.O. BOX 8910, RESTON, VA, 20195, US

(21) Appl. No.: 09/809,066

(22) Filed: Mar. 16, 2001

(51) Int. Cl. H04M 1/00

(52) U.S. Cl. 455/562; 455/103; 455/272

(57) ABSTRACT

In a multiple-carrier modulation system, each carrier signal of the multiple carrier system is distributed, recombined, optionally band pass filtered, and transmitted to downlink devices such as cellular phones. The distribution and recombination is performed by either a space-fed technique or through the use of a Rotman lens fed in reverse. The phases of the distributed signals are controlled to be coherent when recombined. Also, a capacity of the multiple carrier system is enhanced through polarization of the carriers in a space-fed version of the system.

### FIELD OF THE INVENTION

This invention generally relates to combining multiple modulated carriers for use in a wireless communications system.

### BACKGROUND

Modern wireless base station communications systems require transmitter amplifiers that are capable of amplifying two or more modulated carriers simultaneously.

However, the application of multiple simultaneous carriers requires that the amplifiers operate in an extremely linear manner so that undesirable distortion effects are held to a minimum. Most commonly used techniques for minimizing the undesirable distortion effects involve the use of feedforward loops, predistortion correction, or general feedback schemes are both complex and costly.

Also lossy cavity combiners, which must be tuned for given frequencies of operation, can be used to combine the high power outputs of individually amplified carriers, but these are also complex, inefficient (lossy), and costly. These combiners use physically configured cavity resonating filters which dictate the passband and reject-band characteristics. They, at most, typically can only combine carriers associated with each filter's characteristics. This condition precludes the alternation of cellular frequency assignments without physically altering the cavity combiner's characteristics. Thus a need exists for combining multiple carriers in an efficient manner to reduce the cost and complexity.

### SUMMARY OF THE INVENTION

In accordance with the invention, multiple carriers are combined efficiently reducing the cost and complexity. In one aspect of the invention, carriers are space-fed. In the space-fed system, each carrier signal of the multiple carrier system is distributed among multiple paths of an antenna array, collected by a collector, optionally band pass filtered, and transmitted to downlink devices such as cellular phones. The phases of the distributed signals from each path for a carrier are controlled to be coherent at a focal point of the collector. Also, a capacity of the multiple carrier system is enhanced through polarization of the carriers.

In another aspect of the invention, carriers are fed to a Rotman lens in reverse. In the reverse Rotman lens system, each carrier signal of the multiple carrier system is distributed among multiple paths of an antenna array and fed to array ports of the Rotman lens. The energy of the distributed signals is collected at one of the beam ports of the Rotman lens. The carrier signal collected at the beam port is optionally band pass filtered, and transmitted to downlink devices such as cellular phones. The phases of the distributed signals from each path for a carrier are controlled so that the accumulated energy of the distributed signals is maximized at a selected beam port.

### BRIEF DESCRIPTION OF THE DRAWINGS

The accompanying drawings are included to provide a further understanding of the invention and are incorporated in and constitute a part of this specification. The drawings illustrate embodiments of the invention and together with the description serve to explain the principles of the drawings.

In the drawings:

FIG. 1A shows a first embodiment of the present invention wherein phase shifters are used to control phases of signals from array elements;

FIG. 1B shows a variation of the first embodiment where an electromagnetic (E-M) reflector is used to reduce space requirements;

FIG. 2 shows a second embodiment of the present invention wherein array elements are physically distributed to control phases of signals from the array elements;

FIG. 3 shows a third embodiment of the present invention wherein dual polarized configuration is used to increase the capacity; and

FIG. 4 shows a fourth embodiment of the present invention wherein a reverse-fed Rotman lens is used to control phases of signals from array elements, and more efficiently combine multiple carriers.

### DETAILED DESCRIPTION

The embodiments described below can be used to transmit multiple types of signals and are not limited to a specific type. For example, the carrier systems as described can be used to transmit TDMA (time division multiple access), FDMA (frequency division multiple access), and CDMA (code division multiple access) or any other arbitrary modulated or unmodulated carrier signals.

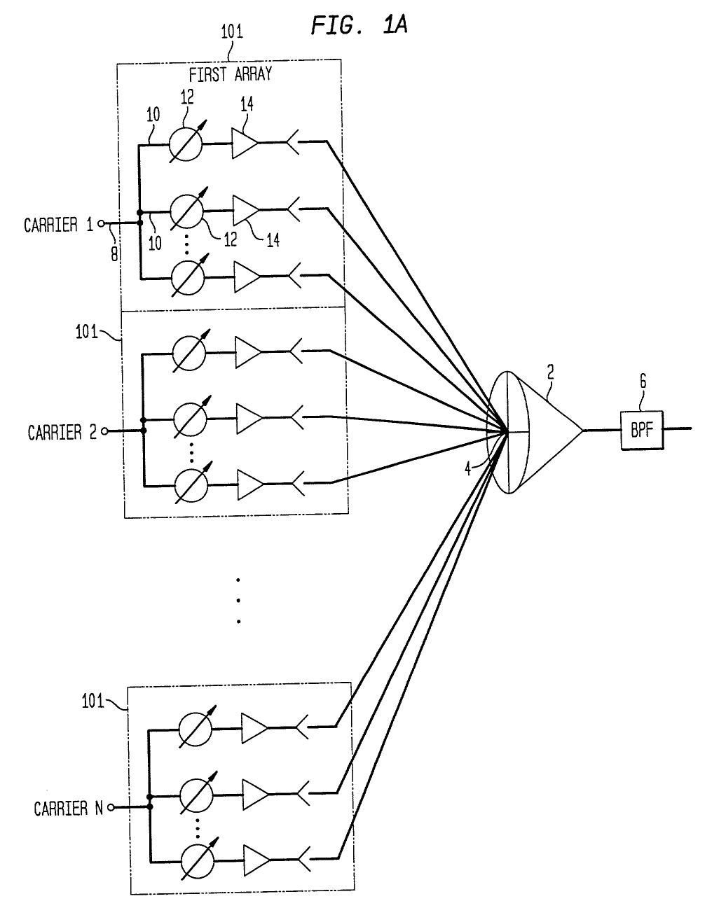

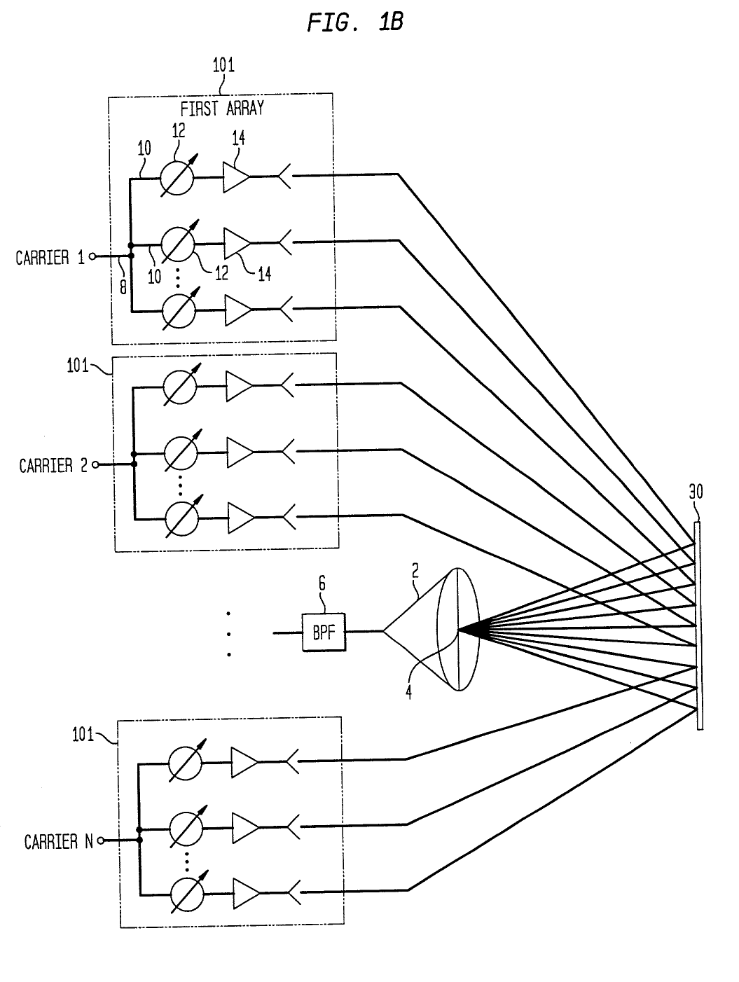

FIG. 1A shows the first embodiment of a multi-carrier system according to the present invention. As shown, the multi-carrier system includes a collector 2 with a focal point 4, a band pass filter 6 connected to the collector 2, and N antenna arrays 101 with each array feeding a particular carrier to the collector 2. The number N is equal to or greater than 2. The focal point 4 of the collector 2 is where the signals from the arrays are collected. The collected signals may be filtered through the optional band pass filter 6 to suppress out of band intermodulation distortions (IMD) and harmonics before being transmitted via one or more antennas (not shown) on the downlink to devices such as a cell phone.

Each antenna array 101 includes an input 8 receiving a carrier signal. Different arrays receive different carrier signals. For example, in FIG. 1A, the first antenna array 101 receives carrier 1 at its input, the second antenna array 101 receives carrier 2 at its input, and so on. Each array also includes M paths 10. The number M is also equal to or greater than 2. The carrier is distributed along the M paths 10 of the array 101.

Note that the number of paths M need not be the same for all arrays. For example, the first array may have five paths while the second array may have six such paths. The number of arrays and the number of paths for each array are limited only by practical considerations such as physical space requirements and cost.

Also as shown in FIG. 1A, each path 10 includes a phase shifter 12 and an amplifier 14. Prior to being fed to the collector 2 as noted above, each distributed signal that travels through a particular path 10 may be phase shifted and/or amplified. However, there is no requirement that a particular path 10 must include one or both of the phase shifter 12 and the amplifier 14 as explained below.

The operation of the first embodiment will now be described. Because all arrays behave similarly, only the operation of the first antenna array 101 feeding carrier 1 to the collector 2 will be described. The first array 101 distributes the carrier 1 signal, received at its input 8, among the paths 10. The phase shifter 12 of a given path 10 controls the phase of the distributed signal, and the amplifier 14 amplifies that distributed signal. The distributed signals are then space fed to the collector 2.

The phase of each distributed signal of the array is controlled so that the distributed signal from that particular path 10 of the first array 101 arrives in modulo 2π phase, i.e., are coherent, relative to other distributed signals from other paths 10 from the same first array 101 at the focal point 4. Preferably, the signals are in perfectly coherent, i.e., all distributed signals from the first array 101 have zero phase delay with respect to each other.

The signals from all paths 10 of the first array 101 arrive at the focal point 4 of the collector 2 and are collected. The collected distributed signals are then combined. The combined signal, which represents a form of the original carrier 1, is optionally band pass filtered by the band pass filter 6 before being transmitted to devices such as cell phones.

As noted above, the distributed signals from a given array are coherent, preferably perfectly coherent, relative to each other at the focal point. However, it is not true that signals from one array must be coherent relative to signals from another array, unless certain arrays are driven by the same modulated carrier. In short, each carrier arriving at the focal point 4 of the collector 2 can be independent of any other carrier.

In FIG. 1A, only one collector 2 is shown. Although not strictly necessary, the single collector 2 with a common focal point 4 is preferred. Having only one collector 2 reduces complexity, cost, and space requirements.

However, it is possible to have multiple collectors 2 with each collector having its associated focal point 4. For example, signals from first and second antenna arrays may be collected by a first collector 2 with a first focal point 4 and signals from third and fourth arrays may be collected by a second collector 2′0 with a second focal point 4′. Respective collectors would combine signals from the arrays and the combined signals may be band pass filtered and transmitted, like the situation described for a single collector.

One use for multiple collectors would be to distribute the workload of combining signals from the arrays. For example, for a typical three sector base station cell, one may wish to dynamically allocate different carriers to different sectors. By including multiple collectors, this problem can be alleviated.

Also, band pass filters with different range of frequency filtering capabilities may be attached to different collectors. This provides the capability selectively filter various frequency ranges, although this may limit the system's frequency agile flexibility.

Further, an electromagnetic (E-M) reflector as shown in FIG. 1B can be used such that focal point of the signals are changed, and thus further reducing space requirements for the device.

Advantages of the first embodiment include cost effectiveness, no carrier limit, high efficiency, and use of common amplifier modules.

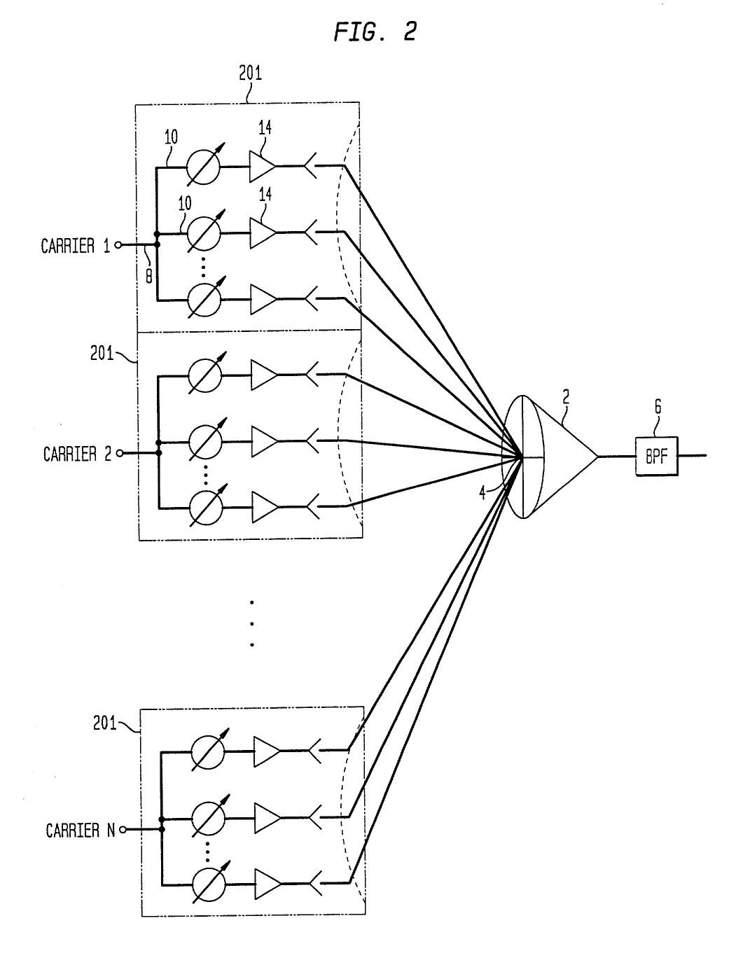

FIG. 2 shows the second embodiment of the multi-carrier system according to the present invention. As shown, the multi-carrier system includes a collector 2 with a focal point 4, a band pass filter 6 connected to the collector 2, and N antenna arrays 201 with each array feeding a particular carrier to the collector 2. The number N is equal to or greater than 2. The focal point 4 of the collector 2 is where the signals from the arrays are collected. The collected signals may be filtered through the optional band pass filter 6 before being transmitted via one or more antennas (not shown) on the downlink to devices such as a cell phone.

Each antenna array 201 includes an input 8 receiving a carrier signal. Different arrays receive different carrier signals. For example, in FIG. 2, the first antenna array 201 receives carrier 1 at its input, the second antenna array 201 receives carrier 2 at its input, and so on. Each array also includes M paths 10. The number M is also equal to or greater than 2. The carrier is distributed along the M paths 10 of the array 201.

Like the first embodiment as described above, the number of paths M need not be the same for all arrays. The number of arrays and the number of paths for each array are limited only by practical considerations such as physical space requirements and cost.

Also as shown in FIG. 2, each path 10 includes an amplifier 14. Prior to being fed to the collector 2, each distributed signal that travels through a particular path 10 maybe amplified.

But, unlike the first embodiment, the second embodiment does not require any phase shifters for reasons described below.

Because all arrays behave similarly, only the operation of the first antenna array 201 feeding carrier 1 to the collector 2 will be described. Like the first embodiment, the first array 201 distributes the carrier 1 signal, received at its input 8, among the paths 10. The amplifier 14 amplifies the distributed signal, and all distributed signals are then space fed to the collector 2.

The signals from all paths 10 of the first array 201 arrive at the focal point 4 coherently, i.e., in modulo 2π phase, relative to each other as explained below. Again, perfect coherence is preferred. The signals are collected by the collector 2 and combined to form a linearly amplified version of the original carrier 1. The combined signal is optionally band pass filtered before being transmitted to devices such as cell phones.

As discussed above, no phase shifters are required. Instead, physical spacing is used to achieve coherence for signals from the paths 10 of the first array 201. Namely, the paths 10 are spaced such that an electrical length of a distributed signal from a particular path 10 is equalized to modulo 2π radians with respect to electrical lengths of distributed signals from other paths 10 at the focal point. The simplest arrangement is that the paths 10 of the first array 201 are all equidistant from the focal point, and this is shown by the dashed parabolas 30 in FIG. 2.

Similarly, the parabolas near other arrays 201 indicate that for each array, the paths of that array are placed so that the electrical lengths of the paths for that array are equalized to modulo 2π radians.

Regarding the first embodiment, it was discussed that while distributed signals from a given array are coherent to each other, the signals from one array are independent from the signals of another array. The same is true of the second embodiment.

Also, like the first embodiment, multiple collectors may be used although a single collector is preferred. Further, for similar reasons, if multiple collectors are used, then multiple band pass filters can be used as well.

Advantages of the second embodiment include cost effectiveness, no carrier limit, high efficiency, and use of common modules. Also, unlike the first embodiment, no phase shifters are required.

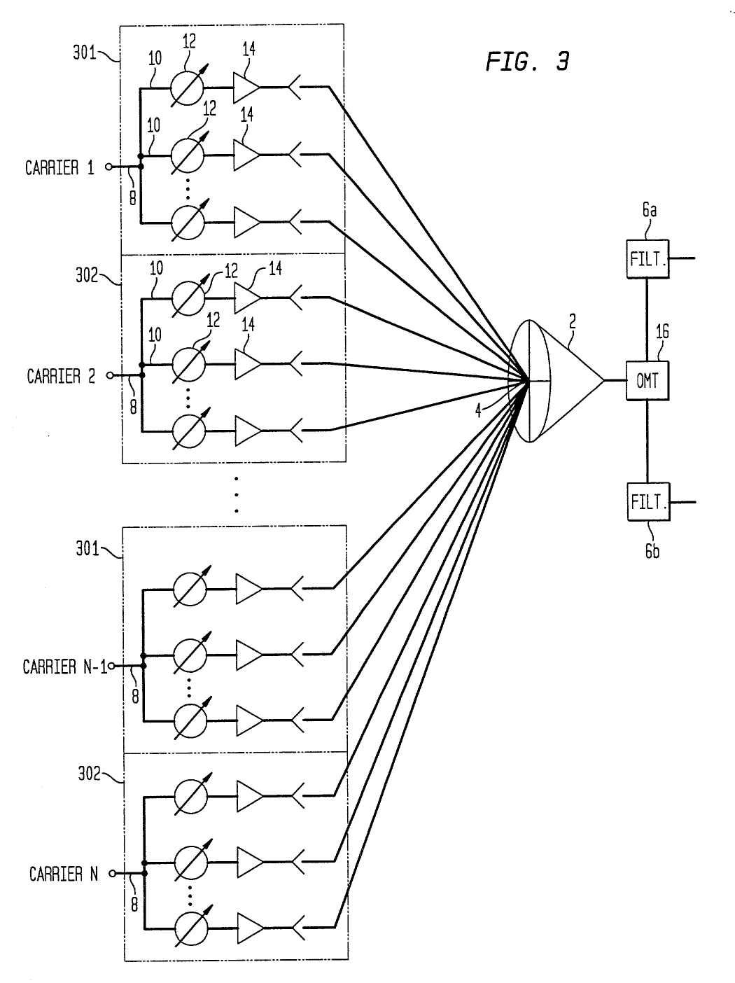

FIG. 3 shows the third embodiment of the multi-carrier system according to the present invention. As shown, the multi-carrier system includes a collector 2, an orthomode transducer (OMT) 16 connected to the collector 2, a first band pass filter 6a and a second band pass filter 6b connected to the OMT 16, antenna arrays 301 and 302, together totaling N in number and each array 301 or 302 feeding a particular carrier to the collector 2. The number N is equal to or greater than 2. The focal point 4 of the collector 2 is where the signals from the arrays are collected. The collected signals may be filtered through the optional first and second band pass filters 6a and 6b before being transmitted via one or more antennas (not shown) on the downlink to devices such as a cell phone.

Each antenna array 301 or 302 includes an input 8 receiving a respective carrier signal. For example, the first antenna array 301 receives carrier 1 at its input 8, the second antenna array 302 receives carrier 2 at its input 8, and so on. Each array also includes M paths 10 as described with respect to FIG. 1. The number M is also equal to or greater than 2, and need not be the same for all arrays. The carrier is distributed along the M paths 10. The total number of arrays 301 and 302 and the number of paths 10 for each array are limited only by practical considerations.

In this third embodiment, the multi-carrier system includes at least two sets of antenna arrays. As shown in FIG. 3, the first array 301 belongs to a first set and the second array 302 belongs to a second set. The two sets of arrays send carrier signals polarized in orientations orthogonal to each other. For example, the first set of arrays 301 may send carrier signals with electric fields polarized in a horizontal orientation and the second set of arrays 302 may send carrier signals with electric fields polarized in a vertical orientation.

Note that the number of arrays of the first set need not be equal to the number of arrays of the second set. Also, there is no requirement that every path of every antenna array must include a phase shifter 12. The paths 10 of the arrays excite the path signals for the required polarizations.

The operation of the third embodiment will now be described. Because all arrays within a set behave similarly, only the operations of the first and second antenna arrays 301 and 302 feeding carriers 1 and 2, respectively, to the collector 2 will be described. The first and second arrays 301 and 302 individually distribute carrier signals 1 and 2, respectively, received at their inputs 8 along the paths 10. The phase shifter 12 of a given path 10 controls the phase of the distributed signal and the amplifier 14 amplifies the distributed signal for each of the first and second arrays.

The distributed signals of both arrays are space fed to the collector 2. Also, the distributed signals of the first array 301 are polarized in a first orientation and the distributed signals of the second array 302 are polarized in second orientation orthogonal to the first orientation.

The phase of each distributed signal of the first array 301 is controlled so that a distributed signal from a particular path 10 of the first array 301 arrives in modulo 2π phase relative to other distributed signals from other paths 10 from the same first array 301 at the focal point 4 of the collector 2. Likewise, the distributed signals from the second array 302 are coherent with respect to each other at the focal point 4 of the collector 2. As stated before, perfect coherence is preferred.

It is not necessary that signals from the first array 301 and the second array 302 be coherent. To put it another way, full independence can be maintained between the respective carrier signals.

The OMT 16 extracts combined carrier signals oriented in the first and second orientations, such as horizontal and vertical, respectively. The extracted signals are optionally band pass filtered via filters 6a and 6b and transmitted via one or more antennas (not shown).

Again, as with. previous embodiments, multiple collectors and multiple filters could be used.

Although not shown, the second embodiment as shown in FIG. 2 can be similarly modified, i.e. there can be first and second sets of arrays with members of each set feeding carrier signals oriented in orthogonal orientations. However, phase coherence would be achieved by fixed physical positioning instead of phase shifting.

Advantages of the third embodiment include cost effectiveness, no carrier limit, high efficiency, and use of common amplifier modules. Also, there is no need for phase shifters and associated driver circuitry or calibration mechanism if the fixed physical positioning option is adopted.

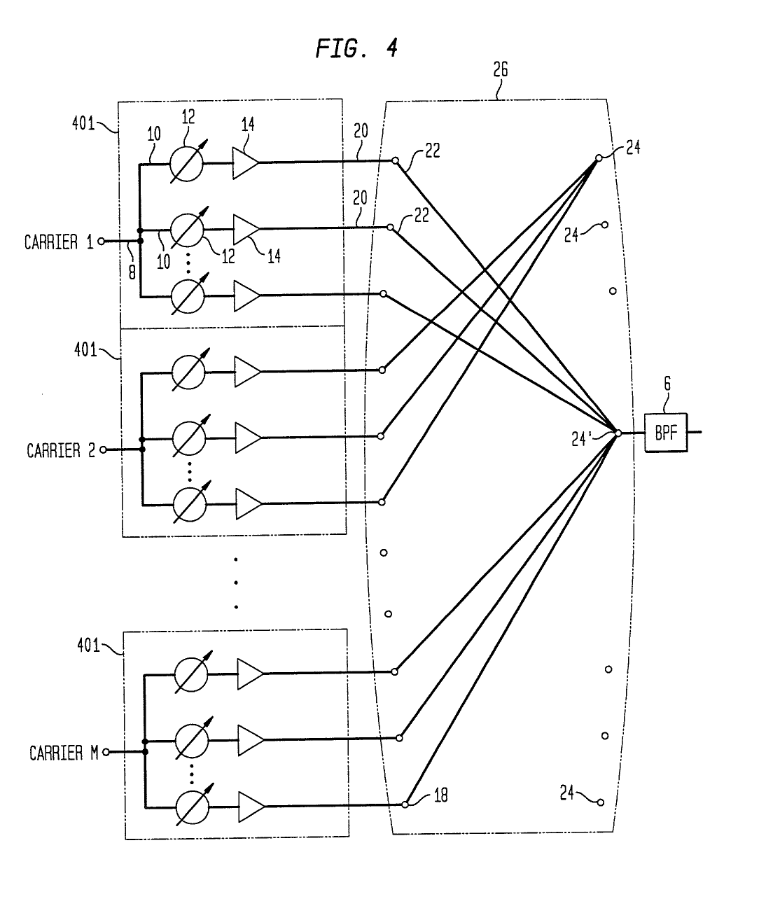

FIG. 4 shows the fourth embodiment of the multi-carrier system according to the present invention. As shown, the fourth embodiment includes a Rotman lens 26, a band pass filter 6 connected to a central beam port 24′ of the Rotman lens 26, and N antenna arrays 401 with each array 401 connected to one or more of the array ports 22 of the Rotman lens 26 via connection cables 20. The number N is equal to or greater than 2.

The Rotman lens 26 includes a plurality of array ports 22 and a plurality of beam ports 24. The beam port at the center is the central beam port and designated with numeral 24′. As noted previously, the band pass filter 6 is connected to the central beam port 24′.

Each antenna array 401 includes an input 8, from which a carrier signal is received. Different arrays receive different carrier signals. For example, in FIG. 4, the first antenna array 401 receives carrier 1 at its input, the second antenna array 401 receives carrier 2 at its input, and so on. Each array also includes M paths 10 as described with respect to FIG. 1A. The number M is also equal to or greater than 2 and this number need not be the same for all arrays. The carrier is distributed along the M paths 10 of the array 401.

Also as shown in FIG. 4, each path 10 includes a phase shifter 12 and an amplifier 14. Prior to being fed to the Rotman lens 26, each distributed signal that travels through a particular path 10 maybe phase shifted and/or amplified. However, there is no requirement that a particular path 10 must include one or both of the phase shifter 12 and the amplifier 14. Indeed, it is preferred that no phase shifters are used to reduce cost and complexity of the device.

The phase shifters may be eliminated by using connecting cables 20 that are phase-determined. In other words, for a given array, it is preferred that the length of each connecting cable 20 be adjusted such that the electrical lengths of distributed signals from that given array to the selected beam port 24 are modulo 2π equal. To illustrate, assume that an array has two paths—a first path and a second path—connected to first and second array ports via first and second connecting cables, all respectively. It is preferred that the physical lengths of the first and second connecting cables are such that the electrical length of the distributed signal from the first path to the first array port 22 is modulo 2π equal to the electrical length of the distributed signal from the second path to the second array port 22. This concept can be extended to more than two paths.

The operation of the fourth embodiment will now be described. Because all arrays behave similarly, only the operation of the first antenna array 401 feeding carrier 1 to the Rotman lens 26 will be described. The first array 401 distributes the carrier 1 signal, received at its input 8, among the paths 10. Optionally, the phase shifter 12 of a given path 10 controls the phase of the distributed signal, and also optionally, the amplifier 14 amplifies that distributed signal. The distributed signals are fed to the Rotman lens 26 via the connecting cables 20. More specifically, distributed signals of the first array 401 are individually fed to a subset of the array ports 22 of the Rotman lens 26 via the connecting cables 20.

In this fourth embodiment, the Rotman lens 26 is driven in reverse. Due to the nature of the Rotman lens 26, the energy of the distributed signals from the paths 10 of the first array 401 add up to a maximum at one of the beam ports 24. This beam port is used to collect the energy of the signals, much like the collector of the previous embodiments. Then the collected energy is optionally band pass filtered and transmitted via one or more antennas to devices such as cellular phones.

The particular beam port 24 where the maximum energy occurs depends on the relative phases of the distributed signals arriving at the array ports 22. For example, if all distributed signals of the first array 401 arrive at the array ports 22 in modulo 2π phase, then the maximum energy will occur at the central beam port 24′. If the phases are offset set from one another, the maximum energy may occur at other beam ports 24. The beam port 24 where the maximum energy occurs is used to collect signals for optional band pass filtering and transmission.

Although lack of phase shifters is preferred, it is possible to have phase shifters 3 controlling the phases of the distributed signals. By controlling the phases, it is possible to choose the beam port 24 where the maximum energy for that array will occur. If more than one beam port is used to collect and transmit signals, workload can be distributed similar to the situations described for other embodiments.

Advantages of the fourth embodiment include cost effectiveness, no carrier limit, high efficiency, use of common modules, no phase calibration requirement, good shielding, small volume, etc. Also, the fourth embodiment allows for flexible allocation and combining of carriers to desired beam ports.

This specification describes various illustrative embodiments of the system and the method of the present invention. The scope of the claims is intended to cover various modifications and equivalent arrangements of the illustrative embodiments disclosed in the specification. Therefore, the following claims should be accorded the reasonably broadest interpretation to cover the modifications, equivalent structures, and features which are consistent with the spirit and the scope of the invention disclosed herein.

We claim:

1. A multiple-carrier wave system, comprising:
a collector including a focal point;
a first antenna array sending a first carrier wave signal, said first antenna array including a first path and a second path wherein said first carrier wave signal is distributed into a first distributed signal sent by said first path of said first antenna array and a second distributed signal sent by said second path of said first antenna array such that said first and second distributed signals of said first carrier wave signal arrive at said focal point of said collector in modulo 2π radian phase coherence with respect to each other; and
a second antenna array sending a second carrier wave signal, said second antenna array including a first path and a second path wherein said second carrier wave signal is distributed into a first distributed signal sent by said first path of said second antenna array and a second distributed signal sent by said second path of said second antenna array such that said first and second distributed signals of said second carrier wave signal arrive at said focal point of said collector in modulo 2π radian phase coherence with respect to each other.

2. The system of claim 1, further comprising:
a first phase shifter controlling said phase of said first distributed signal of said first carrier wave signal; and
a second phase shifter controlling said phase of said second distributed signal of said first carrier wave signal.

3. The system of claim 2, further comprising:
a first amplifier amplifying said first distributed signal of said first carrier wave signal; and
a second amplifier amplifying said second distributed signal of said first carrier wave signal.

4. The system of claim 2, wherein said first and second paths of said second antenna array are physically spaced with respect to the focal point of the collector so that said modulo 2π radian phase coherence of said first and second distributed signals of said second carrier wave signal is achieved.

5. The system of claim 1, wherein said first and second paths of said first antenna array are physically spaced with respect to the focal point of the collector so that said modulo 2π radian phase coherence of said first and second distributed signals of said first carrier wave signal is achieved.

6. The system of claim 5, further comprising:
a first amplifier amplifying said first distributed signal of said first carrier wave signal; and
a second amplifier amplifying said second distributed signal of said first carrier wave signal.

7. The system of claim 1, further comprising:
an E-M reflector reflecting said first and second carrier wave signals changing said focal point of said collector.

8. The system of claim 1, further comprising:
a band pass filter filtering said first and second carrier wave signals collected by said collector.

9. The system of claim 1, wherein said first carrier wave signal sent by said first antenna array is at least one of TDMA, FDMA, and CDMA type.

10. A multiple-carrier wave system, comprising:
a collector including a focal point;
a first antenna array sending a first carrier wave signal, said first antenna array including a first path and a second path wherein said first carrier wave signal is distributed into a first distributed signal sent by said first path of said first antenna array and a second distributed signal sent by said second path of said first antenna array such that said first and second distributed signals of said first carrier wave signal are polarized in a first orientation and arrive at said focal point of said collector in modulo 2π radian phase coherence with respect to each other;
a second antenna array sending a second carrier wave signal, said second antenna array including a first path and a second path wherein said second carrier wave signal is distributed into a first distributed signal sent by said first path of said second antenna array and a second distributed signal sent by said second path of said second antenna array such that said first and second distributed signals of said second carrier wave signal are polarized in a second orientation and arrive at said focal point of said collector in modulo 2π radian phase coherence with respect to each other; and
an orthomode transducer (OMT) extracting from said collector said first and second carrier wave signals polarized in said first and second orientations, respectively.

11. The system of claim 10, wherein said first and second orientations are orthogonal with respect to each other.

12. The system of claim 11, further comprising:
a first phase shifter controlling said phase of said first distributed signal of said first carrier wave signal; and
a second phase shifter controlling said phase of said second distributed signal of said first carrier wave signal.

13. The system of claim 12, further comprising:
a first amplifier amplifying said first distributed signal of said first carrier wave signal; and
a second amplifier amplifying said second distributed signal of said first carrier wave signal.

14. The system of claim 11, wherein said first and second paths of said first antenna array are physically spaced with respect to the focal point of the collector so that said modulo 2π radian phase coherence of said first and second distributed signals of said first carrier wave signal is achieved.

15. The system of claim 14, further comprising:
a first amplifier amplifying said first distributed signal of said first carrier wave signal; and
a second amplifier amplifying said second distributed signal of said first carrier wave signal.

16. The system of claim 10, further comprising:
a first band pass filter filtering said first carrier wave signal polarized in said first orientation and extracted by said OMT; and
a second band pass filter filtering said second carrier wave signal polarized in said second orientation and extracted by said OMT.

17. The system of claim 10, wherein at least one of said first and second carrier wave signals sent by said first antenna array is at least one of TDMA, FDMA, and CDMA type.

18. A carrier wave system, comprising:
a reverse-fed Rotman lens including a set of array ports and a set of beam ports; and
a first antenna array sending a first carrier wave signal, said first antenna array including a first path and a second path wherein said first carrier wave signal is distributed into a first distributed signal sent by said first path of said first antenna array and a second distributed signal sent by said second path of said first antenna array, said first and second paths of said first antenna array being connected to first and second array ports of said set of array ports such that a combined energy of said first and second distributed signals of said first carrier wave signal is a maximum at a first beam port.

19. The system of claim 18, further comprising:
a first connecting cable connecting said first path of said first antenna array to said first array port; and
a second connecting cable connecting said second path of said first antenna array to said second array port.

20. The system of claim 19, wherein said first and second connecting cables are phase-determined such that an electrical length of said first distributed signal from said first path of said first antenna array to said first array port is modulo 2π equal to an electrical length of said second distributed signal from said second path of said first antenna array to said second array port.

21. The system of claim 18, further comprising:
a first phase shifter controlling said phase of said first distributed signal of said first carrier wave signal; and
a second phase shifter controlling said phase of said second distributed signal of said first carrier wave signal.

22. The system of claim 21, further comprising:
a first amplifier amplifying said first distributed signal of said first carrier wave signal; and
a second amplifier amplifying said second distributed signal of said first carrier wave signal.

23. The system of claim 18, further comprising:
a band pass filter filtering said first carrier wave signal collected at said first beam port.

24. The system of claim 18, further comprising:
a second antenna array sending a second carrier wave signal, said second antenna array including a first path and a second path wherein said second carrier wave signal is distributed into a first distributed signal sent by said first path of said second antenna array and a second distributed signal sent by said second path of said second antenna array, said first and second paths of said second antenna array being connected to third and fourth array ports of said set of array ports such that a combined energy of said first and second distributed signals of said second carrier wave signal is a maximum at a second beam port.

25. The system of claim 22, wherein said first and second beam ports are the same.

26. The system of claim 25, further comprising:
a band pass filter filtering said first and second carrier wave signals collected at the common beam port.

27. The system of claim 24, further comprising:
a first band pass filter filtering said first carrier wave signal collected at said first beam port; and
a second band pass filter filtering said second carrier wave signal collected at said second beam port.

29. The system of claim 18, wherein said first carrier wave signal is at least one of TDMA, FDMA, and CDMA signals.

30. The system of claim 18, wherein a phase shift setting associated with each of the first and second paths of the first antenna array is controlled to selectively maximize the combined energy at any one of two or more beam ports of the Rotman lens.
